(19) United States
(12) Patent Application Publication
(10) Pub. No.: US 2016/0227827 A1
(43) Pub. Date: Aug. 11, 2016

(54) RED COLORANT FOR BEVERAGES, FOOD AND PHARMACEUTICAL COMPOSITIONS

(71) Applicant: DSM IP ASSETS B.V., Heerlen (NL)

(72) Inventors: Hansjoerg GRASS, Basel (CH); Andrea HITZFELD, Basel (CH)

(73) Assignee: DSM IP Assets B.V., Heerlen (NL)

(21) Appl. No.: 14/917,765

(22) PCT Filed: Sep. 24, 2014
(86) PCT No.: PCT/EP2014/070389

§ 371 Date: Mar. 9, 2016

(30) Foreign Application Priority Data
Sep. 24, 2013 (CH) 01659/13

(51) Int. Cl. A23L 1/275; A23L 2/58; A61K 31/353

(52) U.S. Cl. CPC A23L 1/2753; A23L 2/58; A23V 2002/00

(57) ABSTRACT

The present invention is directed to rhodoxanthin formulations, whereby the rhodoxanthin is embedded in a matrix of a protective hydrocolloid, the protective hydrocolloid being preferably a modified food starch. The present invention is further directed to the manufacture of such formulations as well as to their use for colouring beverages, food or pharmaceutical compositions, whereby the rhodoxanthin formulations impart an intense red colour to those coloured beverages, food or pharmaceutical compositions. The beverages, food or pharmaceutical compositions which comprise the rhodoxanthin formulations are further aspects of this invention.

The present invention concerns the use of rhodoxanthin formulations as a colouring agent for beverages, food products or pharmaceutical compositions, the formulations containing rhodoxanthin as the colouring agent themselves as well as their manufacturing processes, and beverages, food products or pharmaceutical compositions coloured by formulations containing rhodoxanthin as the colouring agent. The present invention also concerns the use of rhodoxanthin as colouring agent, especially for beverages, food products or pharmaceutical compositions.

Rhodoxanthin (compound of formula I) can be obtained from a natural source, by fermentation or by chemical synthesis. A natural source might be conifers, e.g. plants of Taxus baccata, or Aloa sp. (see e.g. Merzlyak et al., Photochem Photobiol Sci 2005, 4, 333-340). Chemical syntheses are e.g. described in EP-A 077 439 and EP-A 085 763.

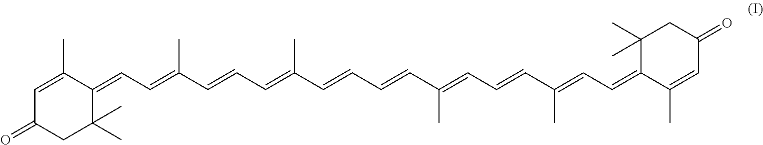 [SMILES: CC1=CC(=O)CC(C)(C)\C1=C/C=C(C)/C=C/C=C(C)/C=C/C=C/C(C)=C/C=C/C(C)=C/C=C1/C(C)=CC(=O)CC1(C)C]

The term “rhodoxanthin” as used herein not only encompasses the (all-E)-isomer, but also any of its mono-, oligo- or poly-(Z)-isomers.

There is an increasing demand of replacing currently used artificial azo dyes in food and beverages by “natural” colorants. Thus, the formulations and beverages, food procucts and pharmaceutical compositions according to the present invention do not contain any artificial azo dyes. Furthermore it is desired that the colour of such beverages and food products containing natural colorants is the same or nearly the same colour of the beverages and food products that contained the artificial azo dyes. Thus, the colour appearance of such beverages and food products should be maintained and not changed.

Until now no replacement was found that gives an intense red colour to beverages, food products and pharmaceuticals compositions and which is not of animal origin. Furthermore, it is also an object of the present invention to provide a simple process for the manufacture of formulations which can be used in an industrial scale to produce large amounts of such formulations.

In accordance with the present invention it has now been found that formulations comprising rhodoxanthin embedded in a matrix of a protective hydrocolloid can be used to impart a red colour to beverages, and food products such as sweet products and dairy products, and to pharmaceutical compositions, such as tablets and capsules. This use represents one aspect of the present invention.

As further aspects, the invention embraces beverages, food products or pharmaceutical compositions containing the formulations comprising rhodoxanthin embedded in a matrix of a protective hydrocolloid in an amount sufficient to impart a red colour to said beverages, food products or pharmaceutical compositions, and the formulations themselves.

Preferably the color hue of the rhodoxanthin formulation of the present invention is in the range of from 30 to 45 (preferably in the range of from 35 to 45, more preferably in the range of from 35 to 40) if said formulation is mixed with water so that the mixture contains 1 to 20 ppm, preferably 5 to 10 ppm, of rhodoxanthin. In this concentration the mixture with water looks red.

For the purpose of the present invention, the formulations comprising rhodoxanthin embedded in a matrix of OSA starch are preferably used, i.e. added to the beverage, the food product or pharmaceutical composition to be coloured or otherwise incorporated in the beverage, the food product or pharmaceutical composition during its preparation, and such a formulation is, as mentioned above, embraced by the present invention.

The formulation comprising rhodoxanthin embedded in a matrix of a protective hydrocolloid may be a solid or a liquid formulation. Preferably, the rhodoxanthin is used as a solid water-dispersible formulation. A liquid formulation containing the rhodoxanthin may be a stable aqueous dispersion of the rhodoxanthin.

The formulations of the present invention are preferably solid, pulverous formulations wherein the contained (total) rhodoxanthin is finely dispersed in a matrix of a protective hydrocolloid. In such formulations the total amount of the rhodoxanthin is suitably from 0.1 to 30 weight-% based on the total weight of the formulation. The protective hydrocolloid used as matrix or carrier can be a carbohydrate, a modified carbohydrate, a protein, a modified protein or any mixture of two or more of these.

The preparation of the formulations of the present invention is preferably carried out as follows:

a) forming a suspension of the rhodoxanthin in a water-immiscible organic solvent optionally containing a fat-soluble antioxidant and/or an oil,

b) feeding the suspension of step a) to a heat exchanger and heating said suspension to 100-250° C., whereby the residence time in the heat exchanger is less than 5 sec,

c) rapidly mixing the solution of step b) at a temperature in the range of 20-100° C. with an aqueous solution of a protective hydrocolloid optionally containing a stabilizer,

d) removing the organic solvent and

e) converting the dispersion of step d) into a pulverous formulation.

The term “finely dispersed” denotes in the scope of the present invention a particle size of less than 1.5 micron, preferably less than 1 micron, more preferably less than 0.4 micron.

Thus, the formulations of the present invention can be prepared by a process which comprises homogenizing, in an aqueous or colloidal solution of the protective hydrocolloid and optionally one or more water-soluble excipients and/or adjuvants, a solution or dispersion of the rhodoxanthin and optionally one or more fat-soluble excipients and/or adjuvants in a triglyceride or an organic solvent, or in a mixture of both triglyceride and organic solvent, and, if required, converting the so obtained dispersion into a solid formulation. The whole process may be typically effected as follows:

The protective hydrocolloid and any optionally present water-soluble excipient(s) and/or adjuvant(s) are dissolved in water, affording an aqueous matrix solution. In a separate step the rhodoxanthin and any optionally present fat-soluble excipient(s) and/or adjuvant(s) are dissolved or suspended in the triglyceride and/or organic solvent. The solution or suspension of the rhodoxanthin is then added to the aqueous matrix solution, and the mixture is homogenized in order to obtain a fine dispersion of the rhodoxanthin in the water phase. Finally, if desired, the dispersion is converted into a solid formulation.

The process for preparing the formulation represents a still further aspect of the present invention.

In the above and further description of the formulations of the present invention containing the rhodoxanthin as the colouring agent and of their preparation the expression “matrix” means the material environment, except water or another solvent and such functional ingredients as antioxidants and antimicrobial agents, in which the rhodoxanthin colouring agent is (eventually) dispersed, or more specifically, encapsulated; in many cases it is synonymous with the expression “carrier”. In the case of solid water-dispersible forms it is the part of the solid formulation which contains the rhodoxanthin, finely dispersed therein, and which dissolves in water when the composition is added thereto, the rhodoxanthin then being evenly dispersed in the aqueous medium.

For the homogenization conventional techniques, such as high pressure homogenization, high shear emulsification (rotor-stator systems) or micronization can be applied. Other techniques used for the preparation of carotenoid compositions for use in beverages and food products are disclosed for example in EP-A 1 008 380 and all such techniques may be employed.

The so obtained dispersion, which is an oil-in-water dispersion, can be converted into a solid formulation, e.g. a dry powder, using any conventional technique such as spray drying, spray drying in combination with fluidized bed granulation (the latter technique being commonly known as fluidized spray drying or FSD), or by a powder-catch technique whereby sprayed emulsion droplets are caught in a bed of an absorbent, such as corn starch, and subsequently dried.

A preferred procedure for preparing a formulation of the present invention comprises preparing a solution or dispersion of the rhodoxanthin and an oil-soluble antioxidant in a triglyceride, e.g. a vegetable oil or fat, and optionally an organic solvent, e.g. a chlorinated hydrocarbon; emulsifying the resulting oil-based solution or dispersion in an aqueous solution prepared from the protective hydrocolloid and, optionally, a water-soluble antioxidant; if required removing the organic solvent, e.g. by evaporation, from the emulsion; drying the emulsion in a manner known per se, e.g. by spraying it into a fluidized starch bed; and finally separating the dried particles, e.g. by sieving.

The above-mentioned protective hydrocolloid is a water-soluble polymeric substance acting as the matrix or carrier material and exerting a protective role towards the rhodoxanthin. As a rule the protective hydrocolloid features surface activity, by virtue of which it stabilizes emulsions or suspensions in which it is present with the rhodoxanthin colouring agent.

The protective hydrocolloid or carrier which may be present in and used to prepare the formulations of the present invention is for example and more particularly a polysaccharide gum, e.g. gum arabic; gum Acacia; gum Ghatti; a modified food starch, e.g. sodium octenyl succinyl starch; a pectin, e.g. sugar beet pectin; a maltodextrin; a protein, e.g. a gelatin, particularly fish, swine, poultry or bovine gelatin, a plant protein or a milk protein; a lignosulphonate; or any mixture of these substances.

Examples of plant proteins are pea proteins, soy proteins and rice proteins which may have been chemically modified or purified.

Preferably the protective hydrocolloid is selected from the group consisting of fish gelatin, modified food starch, lignosulphonate, gum Acacia, gum Ghatti, pea proteins, soy proteins, rice proteins and any mixture thereof, whereby from this group the protective hydrocolloids of non-animal origin are especially preferred.

More preferably a modified food starch and even more preferably sodium octenyl succinyl starch as defined below is used as the protective hydrocolloid or carrier.

A modified food starch is a food starch that has been chemically modified by known methods to have a chemical structure which provides it with a hydrophilic and a lipophilic portion. Preferably the modified food starch has a long hydrocarbon chain as part of its structure (preferably C5-C18).

At least one modified food starch is preferably used to make a formulation of this invention, but it is possible to use a mixture of two or more different modified food starches in one formulation.

Starches are hydrophilic and therefore do not have emulsifying capacities. However, modified food starches are made from starches substituted by known chemical methods with hydrophobic moieties. For example starch may be treated with cyclic dicarboxylic acid anhydrides such as succinic anhydrides, substituted with a hydrocarbon chain (see O. B. Wurzburg (editor), “Modified Starches: Properties and Uses, CRC Press, Inc. Boca Raton, Fla., 1986, and subsequent editions). A particularly preferred modified food starch of this invention has the following formula (I)

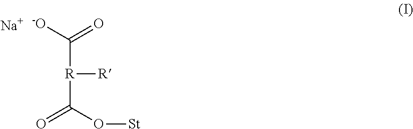

wherein St is a starch, R is an alkylene radical and R′ is a hydrophobic group. Preferably R is a lower alkylene radical such as dimethylene or trimethylene. R′ may be an alkyl or alkenyl group, preferably having 5 to 18 carbon atoms. A preferred compound of formula (I) is an “OSA-starch” (starch sodium octenyl succinate). The degree/extent of substitution, i.e. the number of esterified hydroxyl groups to the number of free non-esterified hydroxyl groups usually varies in a range of from 0.1% to 10%, preferably in a range of from 0.5% to 4%, more preferably in a range of from 3% to 4%.

The term “OSA-starch” denotes any starch (from any natural source such as corn, waxy maize, waxy corn, wheat, tapioca and potato or synthesized) that was treated with octenyl succinic anhydride (OSA). The degree/extent of substitution, i.e. the number of hydroxyl groups esterified with OSA to the number of free non-esterified hydroxyl groups usually varies in a range of from 0.1% to 10%, preferably in a range of from 0.5% to 4%, more preferably in a range of from 3% to 4%. OSA-starches are also known under the expression “modified food starch”.

The term “OSA-starches” encompasses also such starches that are commercially available e.g. from National Starch/Ingredion under the tradenames HiCap 100, Capsul, Capsul HS, Purity Gum 2000, Clear Gum Co03, UNI-PURE, HYLON VII; from National Starch/Ingredion and Roquette Freres, respectively; from CereStar under the tradename C*EmCap or from Tate & Lyle.

In a preferred embodiment of the present invention a commercially available modified food starch such as e.g. HiCap 100 (from National Starch/Ingredion) and ClearGum Co03 (from Roquette Frères) is used. It is especially advantageous if such a starch or an OSA starch in general is further improved according to a process as disclosed in WO 2007/090614, especially according to a procedure as described in examples 28, 35 and/or 36 of WO 2007/090614.

Thus, in a further improved embodiment of the present invention such a commercially available starch has been centrifuged as an aqueous solution or suspension before use. The centrifugation may be carried out at 1000 to 20000 g depending on the dry mass content of the modified food starch in the aqueous solution or suspension. If the dry mass content of the modified food starch in the aqueous solution or suspension is high, the applied centrifugation force is also high. For example for an aqueous solution or suspension with a dry mass content of the modified food starch of 30 weight-% a centrifugation force of 12000 g may be suitable to achieve the desired separation.

The centrifugation may be carried out at dry matter contents in the range of from 0.1-60 weight-%, preferably in the range of from 10-50 weight-%, most preferably in the range of from 15-40 weight-% at temperatures in the range of from 2-99° C., preferably in the range of from 10-75° C., most preferably in the range of from 40-60° C.

Suitably, the formulations of the present invention (further) contain one or more excipients and/or adjuvants selected from one or more of monosaccharides, disaccharides, oligosaccharides and polysaccharides, triglycerides, water-soluble antioxidants and fat-soluble antioxidants. Solid formulations may in addition contain an anti-caking agent, such as silicic acid, and up to 10 weight-%, as a rule 2 to 5 weight-%, of water.

Examples of mono- and disaccharides which may be present in the compositions of the present invention are glucose, fructose, sugar alcohols, lactose, maltose, saccharose and invert sugar.

Examples of the oligo- and polysaccharides are starch and starch hydrolysates, e.g. dextrins and maltodextrins, especially those having the range of 5-65 dextrose equivalents (DE), and glucose syrup, especially such having the range of 20-95 DE. The term “dextrose equivalent” (DE) denotes the degree/extent of hydrolysation and is a measure of the amount of reducing sugar calculated as D-glucose based on dry weight; the scale is based on native starch having a DE close to 0 and glucose having a DE of 100.

The triglyceride is suitably a vegetable oil or fat, preferably corn oil, sunflower oil, soybean oil, safflower oil, rape seed oil, peanut oil, palm oil, palm kernel oil, cotton seed oil or coconut oil.

The organic solvent may be for example methylene chloride, chloroform, ethyl acetate, dimethyl ether, acetone, ethanol or isopropanol.

The water-soluble antioxidant may be for example ascorbic acid or a salt thereof, preferably sodium ascorbate. The fat-soluble antioxidant may be for example α-tocopherol, e.g. dl-α-tocopherol (i.e. synthetic tocopherol), d-α-tocopherol (i.e. natural tocopherol), β- or γ-tocopherol, or a mixture of two or more of these; butylated hydroxytoluene (BHT); butylated hydroxyanisole (BHA); propyl gallate; tert-butyl hydroxyquinoline; or an ascorbic acid ester of a fatty acid, preferably ascorbyl palmitate or stearate. Depending on the pH of the aqueous matrix solution the ascorbic acid ester of a fatty acid, particularly ascorbyl palmitate or stearate, may alternatively be added to the water phase.

### Compounds Not Being Present

In a preferred embodiment of the present invention the formulations are essentially free of the following compounds: polyglycerol esters of edible fatty acids, citric acid esters of monoglycerides of edible fatty esters, citric acid esters of diglycerides of edible fatty esters and any mixture thereof. An edible fatty acid is a saturated fatty acid or an unsaturated fatty acid, which has been approved for use in foodstuffs. The edible fatty acid is preferably a fatty acid selected from the group comprising palmitic acid, stearic acid, oleic acid and erucic acid. The esterified fatty acids can be the same or differ from one another.

In another preferred embodiment of the present invention the formulations are essentially free of the following compounds: esters of mono- and diglycerides of edible fatty acids. Preferred examples of such esters of mono- and diglycerides of edible fatty acids the formulations of the present invention are essentially free of are acetic acid ester of mono- and diglycerides of edible fatty acids (E472a), lactic acid ester of mono- and diglycerides of edible fatty acids (E472b), citric acid ester of mono- and diglycerides of edible fatty acids (E472c) as already mentioned above, tartaric acid ester of mono- and diglycerides of edible fatty acids (E472d), dieacetyl tartaric acid ester of mono- and diglycerides of edible fatty acids (E472e), a mixture of acetic and tartaric acid esters of mono- and diglycerides of edible fatty acids (E472f), and any mixture thereof

In a further preferred embodiment of the present invention the formulations are essentially free of physiologically tolerated polyhydric alcohols. Such physiologically tolerated polyhydric alcohols are especially glycerol, monoesters of glycerol with C₁-C₅-monocarboxylic acids, monoethers of glycerol, propylene glycol or sorbitol. Thus, formulations of the present invention are preferably essentially free of glycerol, monoesters of glycerol with C₁-C₅-monocarboxylic acids, monoethers of glycerol, propylene glycol and sorbitol.

In an especially preferred embodiment of the present invention the formulations are essentially free of all the following compounds: polyglycerol esters of edible fatty acids, citric acid esters of monoglycerides of edible fatty esters, citric acid esters of diglycerides of edible fatty esters, physiologically tolerated polyhydric alcohols, esters of mono- and diglycerides of edible fatty acids and any mixture thereof.

“Essentially free” in the context of the present invention means that these compounds are not added to the formulations of the present invention. If, however, these compounds are present in the formulations of the present invention their amount is below 0.5 weight-%, preferably their amount is below 0.1 weight-%, more preferably their amount is 0 weight-%, based on the total weight of the formulation.

The present invention also encompasses any combination of preferred features of the formulations as disclosed above though not explicitly mentioned.

With the manufacturing processes according to the present invention it is possible to obtain formulations with particles of an average particle size (d₅₀)≦300 nm (measured with Delsa™ Nano S from Beckman Coulter, principle of measurement: The Delsa Nano S uses photon correlation spectroscopy (PCS), which determines particle size by measuring the rate of fluctuations in laser light intensity scattered by particles as they diffuse through a fluid, for size analysis measurements.).

The formulations of the present invention may be solid formulations, i.e. stable, water-soluble or -dispersible powders, or they may be liquid formulations, i.e. aqueous colloidal solutions or oil-in-water dispersions of the aforementioned powders or oil-in-water dispersions of the rhodoxanthin stabilized by low molecular weight food emulsifiers, said emulsifiers being well known as such. The stabilized oil-in-water dispersions, which may be oil-in-water emulsions or may feature a mixture of suspended, i.e. solid, particles and emulsified, i.e. liquid, droplets, may be prepared by the methods already described above.

Typically, a powder formulation according to the present invention comprises
0.1 to 30 weight-%, preferably 1 to 20 weight-%, of the rhodoxanthin;
0 to 20 weight-%, preferably 0.5 to 10 weight-%, of one or more fat-soluble antioxidants;
0 to 50 weight-%, preferably 0.5 to 30 weight-%, of a triglyceride;
1 to 90 weight-%, preferably 5 to 70 weight-%, of the protective hydrocolloid, the protective hydrocolloid preferably being a modified food starch;
0 to 70 weight-%, preferably 0 to 40 weight-%, of one or more mono- or disaccharides;
0 to 50 weight-%, preferably 0 to 35 weight-%, of a starch;
0 to 70 weight-%, preferably 0 to 40 weight-%, of a starch hydrolysate;
0 to 10 weight-%, preferably 0 to 5 weight-%, of a water-soluble antioxidant;
0 to 5 weight-%, preferably 1 to 3 weight-%, of silicic acid; and
0 to 10 weight-%, preferably 1 to 5 weight-%, of water,
the weight percentages of all these ingredients totalling 100.

Examples of beverages containing the rhodoxanthin formulations as a colouring agent and embraced by the present invention are non-alcoholic, flavoured drinks, e.g. flavoured seltzer waters, soft drinks, mineral drinks, flavoured waters, fruit juices, fruit nectars, fruit punches and concentrated forms of these beverages. They may be based on natural fruit or vegetable juices or on artificial juice flavours, and they may be carbonated or non-carbonated. Alcoholic beverages, instant beverage powders, sugar-containing beverages and diet beverages containing non-calorific or artificial sweeteners represent still further examples of beverages which, by virtue of their containing the rhodoxanthin formulations as a colouring agent, are embraced by the present invention.

Furthermore, dairy products obtained from natural sources are within the scope of the food products in which the rhodoxanthin formulations are present as a colouring agent, and as such embraced by the present invention. Typical examples of such dairy products are milk drinks, butter, cheese, ice cream, yoghurt, yoghurt drinks and the like. Milk substitute products such as soy milk products and synthetically produced milk substitute products are also included in the food products containing the rhodoxanthin formulations according to the present invention.

Also included within the scope of the present invention are sweet products containing the rhodoxanthin as a colouring agent, said sweet products including sugar coated confectionery products, e.g. chocolate lentils, boiled sweets, gums, chewing gums, jellies, toffees, hard sugar candies, soft sugar candies and fudges, as well as chocolate confectionary products; and desserts, including frozen desserts, e.g. sorbets, puddings, instant pudding powders and preserves.

Sweet products, especially hard and soft sugar candies, as well as chocolate lentils and beverages are especially preferred.

Also included within the scope of the present invention are fat-based products, e.g. spreads, including low fat spreads and margarine; low calorific food products containing natural or synthetically produced fat replacers; cereals and cereal products, e.g. cookies, cakes and pasta; and snacks, e.g. extruded or non-extruded potato-based products, all of which contain the rhodoxanthin formulations as a colouring agent.

The total concentration of the rhodoxanthin used as a colouring agent in the food products in accordance with the present invention may be from 0.1 to 500 ppm, preferably from 1 to 50 ppm, based on the total weight of the food product. Clearly, the concentration range in any particular case depends on the particular food product to be coloured and on the intended grade of colouration in such food product. The same amounts also apply for beverages.

If the rhodoxanthin is used as a formulation, the total content of the rhodoxanthin in such a formulation may be in the range of from 0.1 weight-% to 30 weight-%, particularly from 1 to 20 weight-%, based on the total weight of the formulation, the most suitable (narrower) content range depending on the particular nature of the formulation, i.e. on which other ingredients are present therein and on its physical form.

The coloured beverages, food products or pharmaceutical compositions of this invention are obtained by adding to or incorporating in the beverage, food product or pharmaceutical composition, at a suitable stage in its manufacture, the rhodoxanthin colouring agent in the form of a formulation of this invention. For such colouration of a beverage, food product or a pharmaceutical composition the formulation of this invention can be used according to methods per se known for the application of water- or oil-dispersible solid or liquid carotenoid forms to bevereages, food products or pharmaceutical compositions, as appropriate.

For the colouration of a beverage or food product the rhodoxanthin formulation may in general be added either as an aqueous stock solution, a dry powder mix or a pre-blend with other suitable food ingredients according to the specific application. Mixing can be effected for example using a dry powder blender, a shear mixer or a homogenizer, depending on the required nature of the final food product or beverage. The particular mixing procedure and amount of oily or aqueous ingredients may influence the colour of the final food product or beverage. As will be readily apparent, such technicalities are within the skill of the expert in the art of beverage and food manufacture and formulation.

The beverages and food products coloured by the rhodoxanthin formulations show an intense red colour, especially if the rhodoxanthin is embedded/encapsulated in modified food starch as protective hydrocolloid.

Preferably the color hue of the rhodoxanthin formulation of the present invention, whereby the rhodoxanthin is embedded in modified food starch, is in the range of from 30 to 45 (preferably in the range of from 35 to 45, more preferably in the range of from 35 to 40) if said formulation is mixed with water so that the mixture contains 1 to 20 ppm, preferably 5 to 10 ppm, of rhodoxanthin. In this concentration the mixture with water looks red.

Pharmaceutical compositions such as tablets or capsules in which the rhodoxanthin formulations are used as a colouring agent are also within the scope of the present invention. The colouration of tablets can be accomplished by adding the solid or liquid rhodoxanthin formulation separately to the tablet coating mixture or by adding the rhodoxanthin formulation to one of the components of the tablet coating mixture. Coloured hard or soft shell capsules can be prepared by incorporating a rhodoxanthin formulation in the aqueous solution of the capsule mass.

The following non-limiting examples illustrate the invention further.

### EXAMPLES 1-3

### Manufacture of a Rhodoxanthin Formulation

### Example 1

10 g of crystalline rhodoxanthin, 1.3 g of dl-α-tocopherol and 4.6 g of corn oil are dissolved in an appropriate solvent (oil phase). This solution is added under stirring to a solution of 100.8 g of modified food starch such as OSA starch and 240 g water at 50-60° C. This pre-emulsion is homogenized with a rotor-stator-homogenizer for 20 minutes. Eventually the emulsion is homogenized with a high pressure homogenizer. In the next step the remaining solvent is removed by distillation and the solvent-free emulsion is dried by a standard powder catch process. 156 g of beadlets are obtained with a rhodoxanthin content of 4.5%.

The colour intensity E1/1 is the absorbance of a 1% solution and a thickness of 1 cm and is calculated as follows: E1/1=(Amax-A650)*dilution factor/(weight of sample*content of product form in %).

“(Amax-A650)” means the value you get when you substract the Adsorption value measured at 650 nm (“A650”) wavelength from the value (“Amax”) that was measured at the maximum Adsorption in the UV-Spectrophotometer.

“*” means “multiplied with”.

“dilution factor”=the factor by which the solution has been diluted.

“weight of sample”=the amount/weight of the formulation that was used in [g]

“content of product form in %”=“the amount of rhodoxanthin in the beadlet in %” which is 4.5 in the present case.

E1/1_{corr}, in H₂O (λ max)=1595 (481 nm)

### Colour Values:

Measured as 5 ppm solution in H₂O: L*/a*/b*=71/35/26; L*/C*/h=71/44/37

Measured as 10 ppm solution in H₂O: L*/a*/b*=54/53/43; L*/C*/h=54/68/39

### Example 2

Example 1 may be repeated, but no corn oil added.

### Example 3

Example 1 may be repeated, but a different oil may be used.

### Example 4

### Preparation of a Soft Drink with the Formulation According to Example 1

The soft drink has the following composition:

| | |
|---|---|
| Ingredient | Amount of ingredient |

| 1 | Potassium sorbate | 0.2 | g |
|---|---|---|---|
| 2 | Sugar syrup (64° Brix) | 156.2 | g |
| | Ascorbic acid | 0.2 | g |
| | Aqueous 50-weight-% citric | 5.0 | g |
| | acid | | |
| | Apricot flavor (water-soluble, | 0.2 | g |
| | Givaudan 78848-56) | | |
| | Stock solution * | 10 g (i.e. 10 ppm) | |
| 3 | Water | Filled up so that a total | |
| | | amount of the soft drink of | |
| | | 1000 ml results | |
| | Total amount | 1000 | ml |

* From the formulation according to example 1 a stock solution was prepared, whereby the formulation was diluted with water so that the stock solution had a concentration of the rhodoxanthin of 0.1 weight-% (=1000 ppm).

The soft drink was prepared as follows:

Potassium sorbate 1) was dissolved in water, the other ingredients 2) were added one after the other while the mixture was gently stirred. Then the resulting soft drink syrup was diluted with drink water in such an amount to result in 1000 ml of the soft drink. The pH of the soft drink was in the range of 3.0 to 3.5.

The soft drink was then filled in a glass bottle and the bottle sealed with a metallic cap. The bottle was pasteurized for approximately 1 min at 80° C. using a tunnel pasteurizer (Miele, Switzerland). The bottles were stored at room temperature (temperature in the range of 18 to 27° C.) and under light exposure. Colour and turbidity measurements were performed directly after beverage preparation (time=0).

### Turbidity Measurements

Suspended solids (or particles) are responsible for the turbid appearance of beverages containing juice. This turbid appearance can be evaluated by turbidity measurements. Turbidity depends on the light-scattering properties of such particles: their size, their shape and their refractive index.

In this work turbidity measurements were conducted using a Turbidimeter (Hach 2100N IS®, USA) and turbidity values were given in NTU (nephelometric turbidity units). Neophelometer measures the light scattered by a sample in 90° from the incident light path.

### Color Measurements

Color measurements for the application in food are performed with a colorimeter (Hunter Lab Ultra Scan Pro) which can other than a spectrophotometer express color values according to the psychophysical perception of color by human eye.

Color measurements are carried out after CIE guidelines (Commission International d'Eclairage). Values can be expressed either as planar coordinates L*a*b* with L* being the measuring value for lightness, with a* being the value on the red-green-axis and with b* being the value on the yellow-blue-axis.

Instrument settings:
Color scale: CIE L*a*b*/L*C*h*
Light source definition: D65 daylight equivalent
Geometry: Diffuse/8°
Wavelengths: scan 350 to 1050 nm in 5 nm optical resolution
Sample measurement area diameter: 19 mm (large)
Calibration mode: Transmission/white tile

### Results

Turbidity: 125 NTU.

### Colour Values

L/a/b=53.51/55.37/38.89; C/h=67.67/35.08

### Comparative Example

A soft drink was prepared using Canthaxanthin 10% CWS/S (commercially available from DSM Nutritional Products Ltd., Kaiseraugst, Switzerland), whereby the concentration of the canthaxanthin in the soft drink was also 10 ppm.

### Results

Turbidity: 168 NTU.

### Colour Values

L/a/b=66.77/40.03/42.49; C/h=58.38/46.71

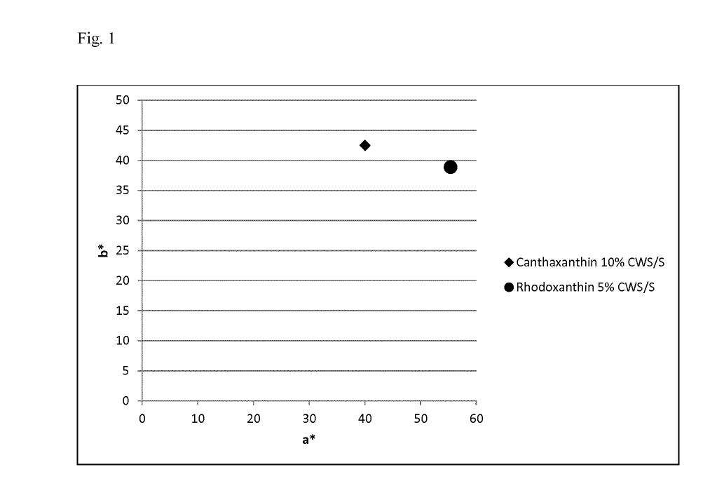

The results of example 4 and the comparative example are also shown in FIG. 1.

The soft drink prepared with the rhodoxanthin formulation according to example 1 is less turbid and redder than the one prepared with Canthaxanthin 10% CWS/S.

### Example 5

### Preparation of Chocolate Lentils with the Formulation According to Example 1

A rhodoxanthin stock solution containing 15 g of the formulation according to example 1 and 85 g of de-ionized water are prepared. 10 g of this rhodoxanthin stock solution are mixed with 490 g of a sugar solution (67-78° Brix) at a temperature of 65° C. under stirring and kept at this temperature resulting in a colored syrup.

Chocolate lentils are pre-coated with a pure sugar solution (without rhodoxanthin) thus providing chocolate lentils with a white center. After this pre-coating a white pigment like titaniumdioxide may be added to the pure sugar syrup and the chocolate lentils may be coated with 10 to 20 layers of this white sugar syrup before they are coated with the colored layers.

A small amount of colored syrup is poured over the lentils and homogenously distributed in the drum at moderate speed. Afterwards the thus colored lentils are dried with air (relative humidity in the range of 40-50%) at moderate speed resulting in one layer. These steps are repeated (usually 20 to 50 times) until the desired color intensity (either red or dark-red or purple depending on how many layers are put on) is achieved.

The hard panned candy has a smooth surface aspect which is enhanced by final glazing layers. The external layers are made of crystalized sugar. According to the sugar layer thickness, the candy offers a lightly or hard crunchy bite.

Color measurements were carried out in a spectrophotometer from Hunter Lab called Ultra Scan PRO. The mode used was RSIN which stands for Reflectance—Specular Included. The small area view (SAV) with a diameter of 4.826 mm (0.190 inch) was chosen for the small and big lentils. The surface of the lentils was held in front of the area view and a light beam was induced on the surface and the reflectance was measured. These measurements resulted in different values. The lightness on a scale from 0 (black) to 100 (white), the a*-value which goes from green (negative value) to magenta (positive value), b*-value which goes from blue (negative value) to yellow (positive value), the chroma which stands for the distance from the center to the point X on an a*b* graph and hue, the angle between the positive a* axis to the point X of the surface was measured.

The Chroma (C) sometimes called saturation describes the vividness or dullness of a color which can be calculated as followed:

C=\sqrt{a²+b²}

The angle called hue (h) describes how we perceive an object's color and can be calculated as followed:

$$h = {tan ( \frac{b}{a} )}^{- 1}$$

### Results

| Color values | Rhodoxanthin |
|---|---|
| L* | 58.53 |
| a* | 32.89 |
| b* | 17.87 |
| C* | 37.43 |
| h | 28.52 |

### Example 6

### Preparation of a Yoghurt Drink with the Formulation According to Example 1

The yoghurt drink has the following composition:

| Ingredient | Amount [g] |
|---|---|
| Milk (3.5 weight-%) | 874 |
| Skim milk powder | 20 |
| Plain yoghurt (3.5 weight-% of fat) | 50 |
| sucrose | 50 |
| Stabilizer (plant hydrocolloid) | 3 |
| Rhodoxanthin 5% CWS/S | 1 for 5 ppm |
| 10% stock solution | 2 for 10 ppm |

Sucrose, milk powder and stabilizer are blended together and added to the milk preheated to 35° C. The 10% stock solution of rhodoxanthin (see also example 4 for its preparation) is added, the mixture is mixed and heated to 70° C. Then the mixture is homogenized at 200 bar/50 bar. Afterwards the mixture is heated to 95° C. for 5 minutes or alternatively to 80° C. for 20 minutes. After having cooled down to 45° C. yoghurt inoculum is added. The fermentation is performed at 43° C. until a pH of 4.6 is reached.

### Color Measurement

Color (lightness, Chroma, and hue) of the dairy product was determined with a HunterLab Ultra Scan Pro spectrocolorimeter (1 cm, REX) (Hunter Associates Laboratory, Reston, Va.,USA) and expressed on basis of the CIELAB color scale.

The UltraScan PRO is a high performance color measurement spectrophotometer that measures the full range of human color perception. It measures after The CIE L*a*b*Color scale. This color scale is an approximately uniform color scale. Meaning the difference between points plotted in the color space correspond to visual difference between color plotted. The measurements were performed using reflectance mode with a wavelength range from 350 nm-1080 nm.

The colour change DE* is calculated as follows:

DE*=\sqrt{(ΔL)²+(Δa)²+(Δb)²}

### Chemical Analysis

The active content was analyzed in the analytics department using RP HPLC. The calibration was performed using Rhodoxanthin standard substance. The accuracy of this measurement is +/−5%.

### Results

The application of Rhodoxanthin 5% CWS/S in a dairy yoghurt drink leads to a reddish strawberry like color shade.

The color difference over 3 weeks storage time (a normal storage time for yoghurt drinks, stored at fridge at 5° C.) is very stable. The DE* value is <3 which is not even visible for human eyes.

TABLE 1
LaCh values after 3 weeks of storage time at 5° C.

| | Yoghurt drink with 5 ppm | Yoghurt drink with 10 ppm |
|---|---|---|
| | of rhodoxanthin | of rhodoxanthin |
| L* | 76.13 | 71.73 |
| a* | 18.11 | 22.6 |
| b* | 11.58 | 13.02 |
| C* | 21.49 | 26.09 |
| h* | 32.6 | 29.94 |

| DE* | 1 Week | 2 Weeks | 3 Weeks |
|---|---|---|---|
| Yoghurt drink with | 0.27 | 0.24 | 0.29 |
| 5 ppm of | | | |
| rhodoxanthin | | | |
| Yoghurt drink with | 0.27 | 0.35 | 0.41 |
| 10 ppm of | | | |
| rhodoxanthin | | | |

The chemical analysis over 3 weeks storage time did not show any instabilities. Both concentrations could be found back to ˜100%.

TABLE 2
Chemical analysis results over storage time

| Sample | Initial | 1 week | 2 weeks | 3 weeks |
|---|---|---|---|---|
| 5 ppm of | 5.75 | 5.37 | 5.68 | 5.73 |
| rhodoxanthin | | | | |
| Retention in [%] | 100 | 93.4 | 98.8 | 99.6 |
| 10 ppm of | 10.3 | 10.6 | 10.3 | 10.5 |
| rhodoxanthin | | | | |
| Retention in [%] | 100 | 103 | 100 | 102 |

1. Use of a rhodoxanthin formulation as an agent for colouring beverages, food products or pharmaceutical compositions, whereby the rhodoxanthin is embedded in a matrix of a protective hydrocolloid in the rhodoxanthin formulation.

2. The use according to claim 1, wherein the food products are dairy products, milk substitute products, sweet products, fat-based products and low calorific food products, cereals and cereal products and snacks which contain one or more of the above-mentioned food products, and the pharmaceutical compositions are tablets or capsules.

3. The use according to claim 1, wherein the concentration of the rhodoxanthin used as the colouring agent in the food product or beverage is from 0.1 to 500 ppm, preferably from 1 to 50 ppm, based on the total weight of the food product.

4. A formulation for colouring beverages, food products or pharmaceutical compositions red, whereby the formulation contains rhodoxanthin embedded in a matrix of a protective hydrocolloid.

5. The formulation according to claim 4, which is a stable water-soluble or water-dispersible powder containing the rhodoxanthin, an aqueous colloidal solution or oil-in-water dispersion of the aforementioned powder, or an oil-in-water dispersion of the rhodoxanthin.

6. The formulation according to claim 4, wherein said protective hydrocolloid is selected from the group consisting of polysaccharide gums, modified food starches, pectins, maltodextrins, proteins, lignosulphonates and any mixture thereof.

7. The formulation according to claim 6, wherein a modified food starch or a mixture of modified food starches is used as protective hydrocolloid.

8. The formulation according to claim 4, wherein the color hue of said formulation is in the range of from 30 to 45 (preferably in the range of from 35 to 45, more preferably in the range of from 35 to 40) if said formulation is mixed with water so that the mixture contains 1 to 20 ppm, preferably 5 to 10 ppm, of rhodoxanthin.

9. The according to claim 4 wherein said formulation is essentially free of the following compounds: polyglycerol esters of edible fatty acids, citric acid esters of monoglycerides, citric acid esters of diglycerides of edible fatty esters and any mixture thereof.

10. The formulation according to claim 4 wherein said formulation is essentially free of physiologically tolerated polyhydric alcohols.

11. The formulation according to claim 4 wherein said formulation is essentially free of esters of mono- and diglycerides of edible fatty acids.

12. A process for preparing a formulation for beverages, food products or pharmaceutical compositions as claimed in claim 4, characterized by homogenizing, in an aqueous or colloidal solution of a protective hydrocolloid and optionally one or more water-soluble excipients and/or adjuvants, a solution or dispersion of the rhodoxanthin and optionally one or more fat-soluble excipients and/or adjuvants in a triglyceride or an organic solvent, or in a mixture of both triglyceride and organic solvent, and, if required, converting the so obtained dispersion into a solid composition.

13. A formulation as obtained by the process according to claim 12.

14. A beverage, food product or pharmaceutical composition, especially a beverage, a dairy product, a milk substitute product, a sweet product, a fruit preparation, a fat-based product, a low calorific food product, a cereal, a cereal product and a snack, which contain one or more of the above-mentioned food products, or, respectively, tablets or capsules, characterized by comprising a rhodoxanthin formulation according to claim 4 as a colouring agent.

15. Use of rhodoxanthin as colouring agent, especially for beverages, food products and pharmaceutical compositions.
